(19) United States
(12) Patent Application Publication
(10) Pub. No.: US 2010/0079092 A1
(43) Pub. Date: Apr. 1, 2010

(54) REAL TIME LOAD ADAPTATION OF A MOTOR

(75) Inventors: William B. Carpenter, Cleveland, TN (US); Edward M. Hinson, Madison, AL (US); Patrick M. Kinsella, Atlanta, GA (US)

Correspondence Address: Patrick M. Kinsella, 50 Biscayne Drive-# 5108, Atlanta, GA, 30309, US

(73) Assignee: ADARA LABS, Madison, AL (US)

(21) Appl. No.: 12/239,849

(22) Filed: Sep. 29, 2008

(51) Int. Cl. G05B 19/042

(52) U.S. Cl. 318/164

(57) ABSTRACT

A method of varying speed and direction of motor operating intervals in a food processing device to achieve real time load adaptation comprising a motor (512), control circuit (501), motor drive circuit (511), and voltage and current sense circuits (510) to control said motor based on ingredient and desired function input from a user input device (509) and known motor and ingredient load profile data stored in non-volatile memory (504). An analog to digital converter (502) is used to read motor load data using voltage and current sense circuits (510) to index said motor and ingredient load profile data enabling said control circuit (501) to alter speed and direction of motor (512) operation to provide consistency in results of final mixture irregardless of variations of initial ingredient quantity and viscosity.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to control methods of alternating current (AC) motors in appliances such as food processing devices.

2. Prior Art

Early food processing devices acknowledged the need to adjust motor operation based on the ingredients and recipe. U.S. Pat. No. 2,740,029 to Kueser et al (1956) address the concept of offering a plurality of speed options to the operator. The added feature of operating for a predetermined period of time based on a mode selection is addressed in U.S. Pat. No. 2,912,633 to Nebinger et al (1959).

One method for controlling a blender is described in U.S. Pat. No. 3,548,280 to Cockroft (1970) providing a plurality of speed selection switches which control the firing angle of an SCR connected in series with the motor. U.S. Pat. No. 5,347,205 to Piland (1994) describes a control method using a microcontroller to interpret user input and control the firing angle of an AC switch in series with the motor.

U.S. Pat. No. 3,612,969 to Cockroft (1971) introduced the concept of a known motor speed for a certain ingredient list, where the user simply inputs a pre-punched recipe card to provide input to motor control circuitry. Most conventional blenders adopted the method of U.S. Pat. No. 3,943,421 to Shibata et al (1976) where a user control panel contains a plurality of buttons with individual ingredient or finished food labels corresponding to appropriate motor speeds, where the selected buttons act as input to the motor control circuitry. This can be very limiting as any changes to speed or direction during processing are manual, requiring user intervention and allowing for inconsistent results from one operation to the next.

U.S. Pat. No. 6,364,522 to Kolar et al (2002) acknowledges this shortcoming in describing a blender where a user can store a plurality of operations into memory for future use. This allowed for the user to program for multiple ingredient blends requiring a series of motor operating intervals in different directions with corresponding speed and acceleration, storing said programs into non-volatile memory. However, consistency of results can not be insured for variations in quantity of ingredients or ingredient homogeny as the program intervals are fixed based on initial user input from a single operation.

U.S. Pat. No. 6,609,821 to Wulf et al (2003) describes a blender in which a plurality of pre-determined programs is stored in non-volatile memory, accessed by a microcontroller executing the respective commands to deliver motor operating intervals based on user selection of ingredients and known characteristics of the blade and container for most favorable recipe results. However, again, consistency of results can not be insured for variations in quantity of ingredients or ingredient homogeny.

U.S. Pat. No. 7,290,724 to Lin et al (2007) presents a blender that determines food processing conditions from initial motor speed value with an operator input of only course or fine processing mode. However, the operator is unable to select ingredients or desired consistency of final recipe to affect the program. Food ingredients frequently have similar initial consistency but require different motor operation intervals to achieve desired results. Hence, consistency of results can not be insured for different ingredients or desired consistency of food after processing.

A solution is needed to provide a food processing device allowing users to select an ingredient profile and/or desired consistency of final food mixture for which the device is able to output consistent results notwithstanding differences in total quantity of raw mixture.

### SUMMARY

In accordance with one embodiment, a method of varying speed and direction of a motor in an appliance, such as a food processing device, to achieve real time load adaptation. This method significantly improves upon prior art in delivering more consistent results in line with user selected function, notwithstanding initial ingredient variables such as viscosity and quantity.

### DRAWINGS

### Figures

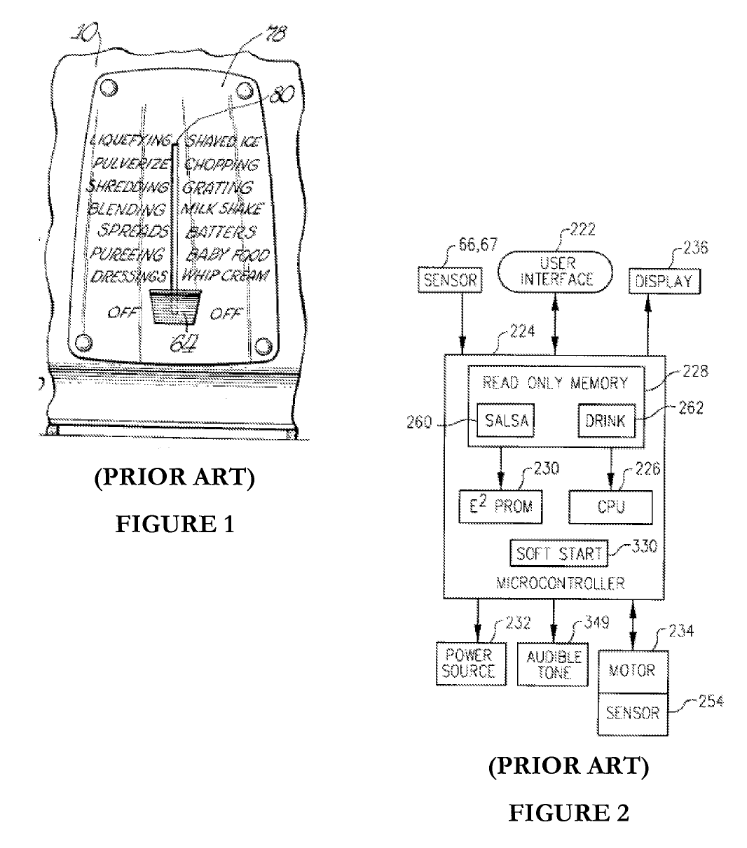

FIG. 1 (from U.S. Pat. No. 2,740,029 to Kueser et al) depicts an early blender control panel that varies speed based on user selection of an ingredient

FIG. 2 (from U.S. Pat. No. 6,609,821 to Wulf et al) shows a block diagram of a food processor equipped with pre-programmed operating intervals and velocities based on user input

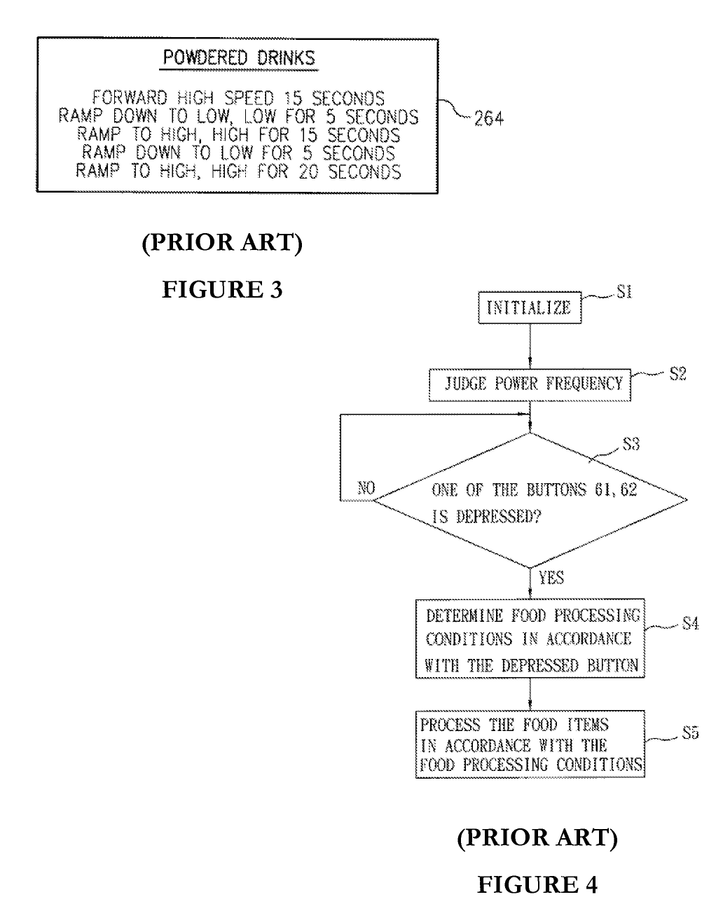

FIG. 3 (from U.S. Pat. No. 6,609,821 to Wulf et al) shows an example of a pre-programmed operating interval sequence based on a desired ingredient selection, regardless of ingredient quantity

FIG. 4 (from U.S. Pat. No. 7,290,724 to Lin et al) depicts a processing sequence of a blender determining operating modes from motor rotation speed only without any user ingredient input, regardless of ingredient quantity

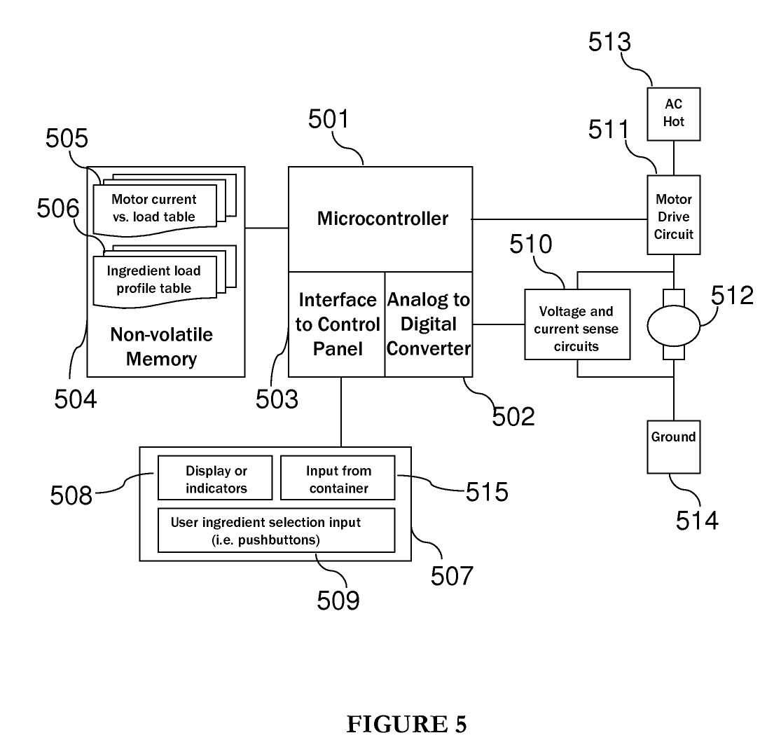

FIG. 5 is a system level diagram of one embodiment

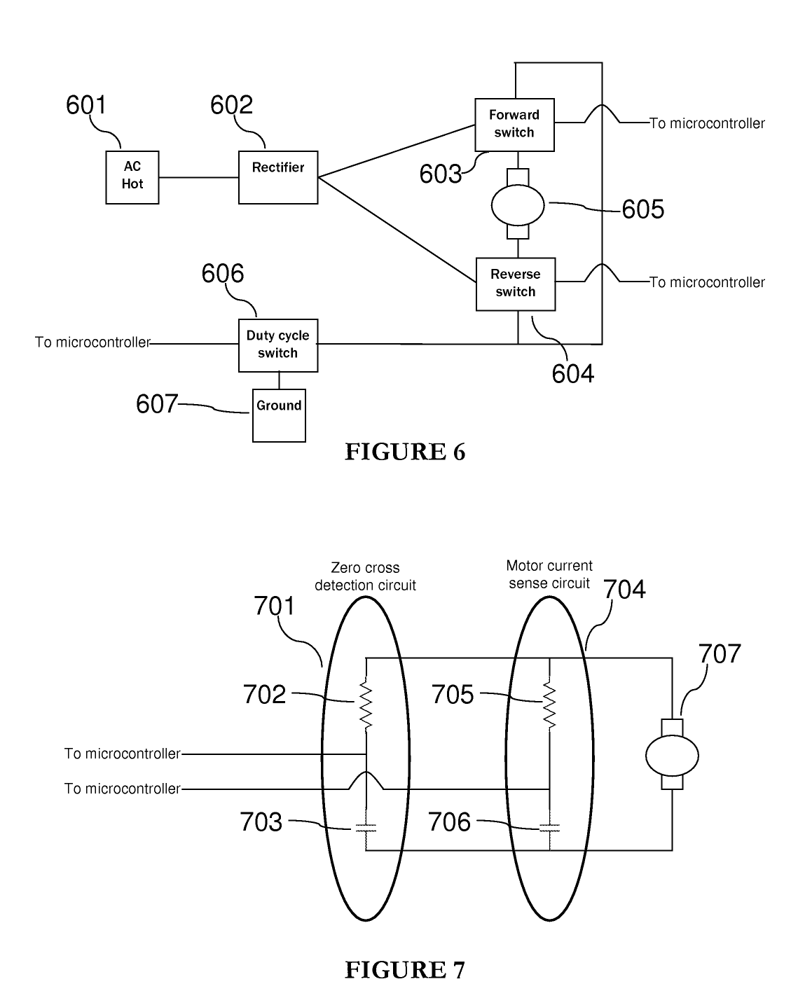

FIG. 6 is a block diagram of the motor drive circuit from one embodiment shown in FIG. 5

FIG. 7 is a block diagram of the motor voltage and current sensing circuit from one embodiment shown in FIG. 5

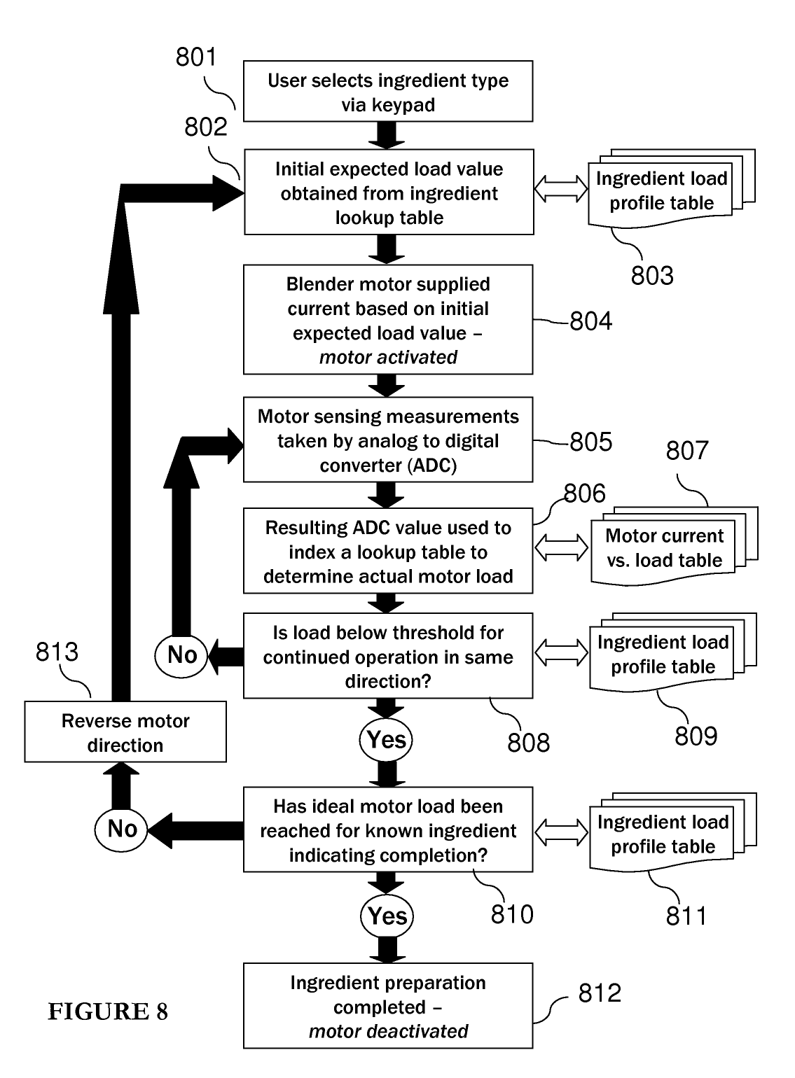

FIG. 8 depicts a processing sequence of one embodiment

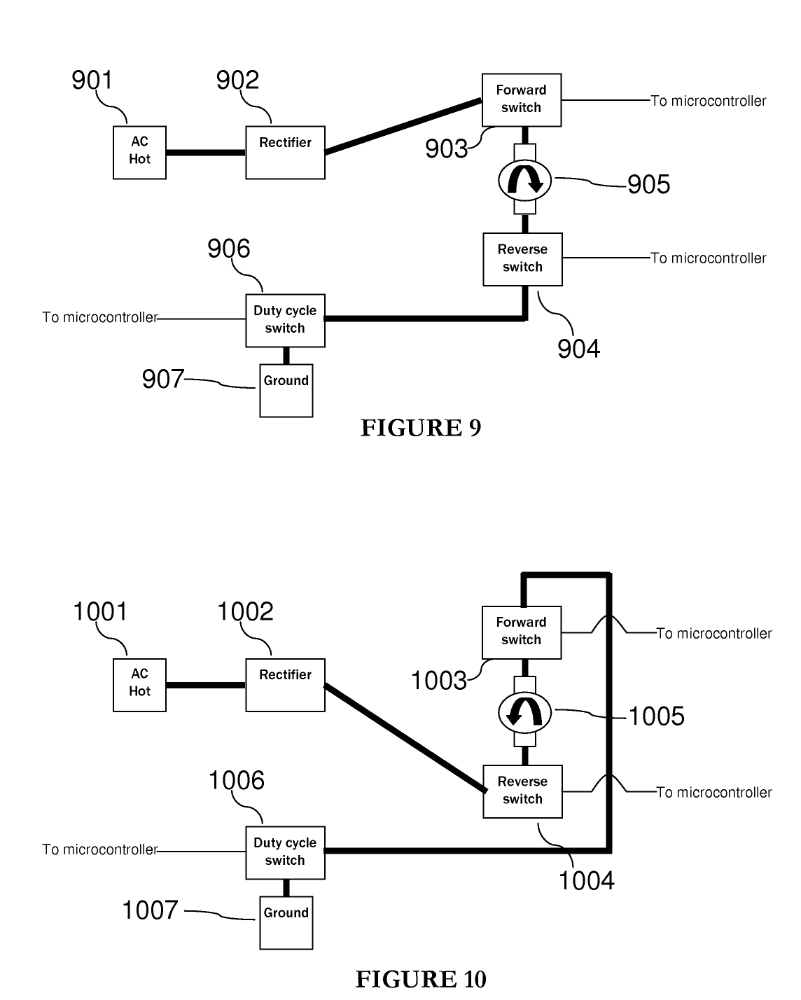

FIG. 9 depicts the energy flow through the motor drive circuit as the motor rotates in the forward or clockwise direction

FIG. 10 depicts the energy flow through the motor drive circuit as the motor rotates in the reverse or counter-clockwise direction

### DRAWINGS

### Reference Numerals

501—A microcontroller integrated circuit
502—An analog to digital converter
503—An interface to a user control panel
504—Non-volatile memory (i.e. EEPROM)
505—A motor current vs. load table stored in non-volatile memory 504
506—An ingredient load profile table stored in non-volatile memory 504
507—A user control panel
508—A display on user control panel 507
509—Selection input (i.e. buttons) on user control panel 507
510—Motor voltage and current sensing circuit
511—Motor drive circuit
512—A motor
513—AC hot power connection
514—Ground
515—Input (i.e. safety, identification) switches from ingredient container
601—AC hot power connection
602—A rectifier
603—A switch to rotate the motor in the forward or clockwise direction
604—A switch to rotate the motor in the reverse or counter-clockwise direction
605—A motor
606—A duty cycle switch
607—Ground
701—A zero cross detection circuit
702—A resistor used for zero cross detection
703—A capacitor used for zero cross detection
704—A motor current sense circuit
705—A resistor used for motor current sensing
706—A capacitor used for motor current sensing
707—A motor
801—User input step
802—Initial load value lookup step
803—An ingredient load profile table stored in non-volatile memory 504
804—Initial motor activation step
805—Motor sensing measurement step
806—Motor current lookup step
807—A motor current vs. load table stored in non-volatile memory 504
808—Load threshold decision step
809—Said ingredient load profile table stored in non-volatile memory 504
810—Operation completion threshold decision step
811—Said ingredient load profile table stored in non-volatile memory 504
812—Motor deactivation step, operation complete
813—Motor reversing step
901—AC hot power connection
902—A rectifier
903—A switch to rotate the motor in the forward or clockwise direction
904—A switch to rotate the motor in the reverse or counter-clockwise direction
905—A motor
906—A duty cycle switch
907—Ground
1001—AC hot power connection
1002—A rectifier
1003—A switch to rotate the motor in the forward or clockwise direction
1004—A switch to rotate the motor in the reverse or counter-clockwise direction
1005—A motor
1006—A duty cycle switch
1007—Ground

### DETAILED DESCRIPTION

### FIGS. 5, 6, 7

The system level diagram in FIG. 5 illustrates the key components of one embodiment and how they are connected. A microcontroller 501 acts as the main control point for operation of one embodiment. The microcontroller 501 is connected to a motor drive circuit 511. The motor drive circuit 511 connects an AC hot power connection 513 with a motor 512. The other side of the motor 512 is connected to an AC neutral power connection 514. An analog to digital converter 502 is included within the microcontroller 501, but can be an external component connected to the microcontroller 501. The analog to digital converter 502 is connected to the voltage and current sense circuits 510, which are connected to the motor 512. The microcontroller 501 is also connected to a non-volatile memory 504 which contains tables for motor current versus load 505 and ingredient load profiles 506. An interface to control panel 503 is contained within the microcontroller 501 but can be an external component connected to the microcontroller 501. The interface to control panel 503 is connected to a user control panel 507, containing a display or bank of indicators 508 and a method of user ingredient selection input 509 such as pushbuttons. Control panel 507 also contains input and/or safety switches 515 from the attached container of the food processing unit for safety control and identification of the cutting surfaces to determine appropriate loading data.

The block diagram illustrated in FIG. 6 depicts the motor drive circuit 511 from one embodiment shown in FIG. 5. An AC hot connection 601 is connected to a rectifier 602. The rectifier 602 is in turn connected to the hot inputs of forward switch 603 and reverse switch 604. A duty cycle switch 606 switches a connection from ground 607 to the ground inputs of forward switch 603 and reverse switch 604. A motor 605 is connected on one end to forward switch 603 and on the other end to reverse switch 604. Forward switch 603 and reverse switch 604 also have outgoing control lines which connect to microcontroller 501. Duty cycle switch 606 also has an outgoing control line which connects to microcontroller 501.

FIG. 7 comprises a diagram of the voltage and current sense circuits 510 from one embodiment shown in FIG. 5. A zero cross detection circuit 701 is comprised of a resistor 702 where the hot side of the resistor 702 is connected to the hot input side of the motor 707 and a capacitor 703 where the ground side of the capacitor 703 is connected to the ground input side of the motor 707. The ground side of the resistor 702 is connected to the hot side of the capacitor 703, from which an outgoing control line connects to microcontroller 501. A motor current sense circuit 704 is comprised of a resistor 705 where the hot side of the resistor 705 is connected to the hot input side of the motor 707 and a capacitor 706 where the ground side of the capacitor 706 is connected to the ground input side of the motor 707. The ground side of the resistor 705 is connected to the hot side of the capacitor 706, from which an outgoing control line connects to microcontroller 501.

### OPERATION

### FIG. 5,7,8,9,10

The processing sequence shown in FIG. 8 illustrates the mode of operation of one embodiment based on the system level diagram in FIG. 5. In the user input step 801, the user selects an ingredient and/or desired final mixture using user ingredient selection input 509. Based on this user input, initial load value lookup step 802 comprises the microcontroller 501 accessing the ingredient load profile table 803 (506) inside non-volatile memory 504 to determine initial motor operating interval value after verifying proper settings of input from container switches 515. During initial motor activation step 804, the microcontroller 501 sends the appropriate initial value control signal to motor drive circuit 511 activating motor 512 at a zero crossing point by measuring the zero cross of the incoming power using zero cross detection circuit 701, resulting in an energy flow depicted in FIG. 9.

A motor sensing measurement step 805 comprises the analog to digital converter 502 reading motor electrical data from motor current sense circuit 704 and feeding said measurements into microcontroller 501. In motor current lookup step 806, the microcontroller 501 accesses the motor current vs. load table 807 (505) inside non-volatile memory 504 to determine the actual loading of the motor 512. In the decision step 808, the microcontroller 501 looks up the load value obtained in step 806 in the ingredient load profile table 809 (506) in non-volatile memory 504 and determines if the actual motor load is below the threshold for continued operation in the same rotational direction for the ingredient and/or desired final mixture selected by the user in user input step 801. If the actual motor load is not below the threshold for continue operation in the same rotational direction, the microcontroller 501 will repeat steps 805, 806, and 808. Once the actual motor load is below the threshold for continued operation in the same rotational direction for the ingredient and/or desired final mixture selected by the user in input step 801, operation completion threshold decision step 810 comprises the microcontroller 501 accessing the ingredient load profile table 811 (506) and comparing the actual motor load value from the most recent iteration of motor sensing measurement step 805 to determine if the actual motor load is below a threshold indicating that the contents have reached the users desired form (as a reflection of the viscosity and homogeny of the contents of the food processing device). If the actual motor load is not below said threshold, motor reversing step 813 comprises the microcontroller 501 sending the appropriate control signal to the motor drive circuit 511 to reverse the direction of motor 512 at a zero crossing point by measuring the zero cross of the incoming power using zero cross detection circuit 701 and processes initial load value lookup step 802, motor activation step 804 (in an opposite direction of rotation from FIG. 9, with energy flow now depicted in FIG. 10), and begins the cycle of repeating steps 805, 806, 808. If during operation completion threshold step 810 the actual motor load is below said threshold, motor deactivation step 812 occurs at a zero crossing point by measuring the zero cross of the incoming power using zero cross detection circuit 701 indicating that processing of the ingredients has been completed.

FIG. 9 depicts the energy flow within the motor drive circuit 511 of one embodiment during an operating interval for forward or clockwise motor rotation. The microcontroller 501 sends a signal engaging the forward switch 903, and disengaging the reverse switch 904, connecting the motor to the voltage from AC hot 901 after it has been rectified by rectifier 902. The microcontroller 501 also pulses duty cycle switch 906 based on the expected load value determine in motor activation step 804 providing a pulsed connection to ground 907 and completing the circuit to energize the motor 905 in the forward or clockwise direction at a rotational speed determined by the pulse width provided to the duty cycle switch 906 by the microcontroller 501.

FIG. 10 depicts the energy flow within the motor drive circuit 511 of one embodiment during an operating interval for reverse or counter-clockwise motor rotation. The microcontroller 501 sends a signal engaging the reverse switch 1004, and disengaging the forward switch 1003, connecting the motor to the voltage from AC hot 1001 after it has been rectified by rectifier 1002. The microcontroller 501 also pulses duty cycle switch 1006 based on the expected load value determine in motor activation step 804 providing a pulsed connection to ground 1007 and completing the circuit to energize the motor 1005 in the reverse or counter-clockwise direction at a rotational speed determined by the pulse width provided to the duty cycle switch 1006 by the microcontroller 501.

The thresholds stored in the motor current versus load table 505 and ingredient load profile table 506 can both be adjusted by one skilled in the art to achieve ideal results based on the selection of motor 512, container, and cutting surfaces for a variety of ingredients and desired final mixture viscosity and homogeny.

### CONCLUSION, RAMIFICATIONS, AND SCOPE

Accordingly, the reader will see that at least one embodiment of this method of varying speed and direction of a motor in an appliance to achieve real time load adaptation can be used to provide more consistent results in food processing than is currently available by affording the following advantages:
A) Greater consistency in desired viscosity and homogeny across the following conditions:
   a. Quantity variation of initial ingredients
   b. Inconsistency of viscosity of initial ingredients across different ingredient manufacturers
   c. Different or replaced containers and/or cutting surfaces
B) Simplified operation for the user
C) Low cost design allows for greater market proliferation of the product:
   a. Can be manufactured using economical, commercially available components
   b. Can be manufactured using an cost-effective universal motor

While my above description contains many specificities, these should not be construed as limitations on the scope of the invention, but rather as an exemplification of one embodiment thereof. Many other variations are possible. For example, the microcontroller chosen as the control center for the control method can easily be replaced with other semiconductor technology including but not limited to a state machine, application specific integrated circuit, etc. Also, there are many possible variations to the motor drive circuit and voltage and current sense circuits.

Alternative embodiments are possible to support different appliances outside of the food preparation discipline including but not limited to power tools. Additional components may also be added to support additional features such as user adjustable thresholds, removable memory devices for use of said thresholds in compatible devices, etc.

Thus, the scope of the embodiment should be determined by the appended claims and their legal equivalents, rather than by the examples given.

I claim:

1. A method of varying speed and direction of a motor in an appliance comprising:
(a) providing a motor,
(b) providing a dynamic load,
(c) providing a control circuit,
(d) providing a motor drive circuit,
(e) providing a sense circuit or plurality of sense circuits,
(f) providing a non-volatile memory,
(g) providing a known ingredient load profile table stored in said non-volatile memory,
(h) providing a known motor load profile table stored in said non-volatile memory,
(i) providing a user interface,
(j) said control circuit coupled with said motor drive circuit to vary speed and direction of said motor based on feedback said control circuit receives from said sense circuit or plurality of sense circuits in accordance with said known ingredient load profile table, said known motor load profile, and input from said user interface,
whereby said motor operation can be adjusted by said control circuit in real time to adapt to said dynamic load to provide consistent results in accordance with desired function despite variations in said dynamic load.

2. The method of claim 1 wherein said control circuit includes a microcontroller.

3. The method of claim 1 wherein said control circuit includes an analog to digital converter.

4. The method of claim 1 wherein said control circuit includes a state machine.

5. The method of claim 1 wherein said motor drive circuit includes components comprising:
(a) providing an alternating current hot power connection,
(b) providing a rectifier coupled to said alternating current hot power connection,
(c) providing a ground connection,
(d) providing a duty cycle switch coupled to said ground connection,
(e) providing a forward switch coupled to said rectifier and coupled to said duty cycle switch and coupled to said control circuit and coupled to said motor, (f providing a reverse switch coupled to said rectifier and coupled to said duty cycle switch and coupled to said control circuit and coupled to said motor,
wherein said forward switch and reverse switch are directed by said control circuit to function in two states,
A) in the forward state said control circuit engages said forward switch and disengages said reverse switch to conduct current from said rectifier through said forward switch through said motor into said reverse switch to said ground connection via said duty cycle switch wherein the velocity of said motor is controlled by said control circuit adjusting duty cycle of said duty cycle switch,
B) in the reverse state said control circuit engages said reverse switch and disengages said forward switch to conduct current from said rectifier through said reverse switch through said motor into said forward switch to said ground connection via said duty cycle switch wherein the velocity of said motor is controlled by said control circuit adjusting duty cycle of said duty cycle switch.

6. The method of claim 1 wherein said sense circuit or plurality of sense circuits includes a zero cross detection circuit.

7. The method of claim 1 wherein said sense circuit or plurality of sense circuits includes a motor current sense circuit.
